(19) United States
(12) Patent Application Publication
(10) Pub. No.: US 2003/0126555 A1
(43) Pub. Date: Jul. 3, 2003

(54) Enhanced attribute prompting in browser clients

(75) Inventors: Radhika Aggarwal, Raleigh, NC (US); William H. Krebs JR., Cary, NC (US); Elizabeth A. Schreiber, Apex, NC (US); David B. Styles, Cary, NC (US)

Correspondence Address: IBM Corporation T81/062, P.O. Box 12195, Research Triangle Park, NC, 27709, US

(73) Assignee: International Business Machines Corporation, Armonk, NY

(21) Appl. No.: 10/041,179

(22) Filed: Jan. 3, 2002

(51) Int. Cl. G06F 15/00

(52) U.S. Cl. 715/505

(57) ABSTRACT

An enhanced form-based input element attribute prompting system. The system can include a servlet configured to process requests for enhanced form-based input elements, each request encapsulating at least one input element attribute associated with a requested enhanced form-based input element; and, a graphical element generation processor configured to generate an enhanced form-based input element based upon at least one specified input element attribute provided by the servlet. Each enhanced form-based input element generated by the graphical element generation processor can include a form-based input element and at least one form-based input element attribute prompt. Additionally, the attribute prompt can include least one attribute selected from the group consisting of a textual description of validation criteria, a graphical indication of input-element state, and a graphical indication of an available field action.

### BACKGROUND OF THE INVENTION

1. Statement of the Technical Field

The present invention relates to the field of user interface rendering and more particular to rendering form-based input fields in a content browser.

2. Description of the Related Art

Prior to the popularization of the Internet and the subsequent implementation of the World Wide Web (“the Web”), software publishers typically distributed computer applications via storage media such as a computer diskette or compact disc. Initially, such stand-alone computer applications included underlying program logic, data storage and, optionally, a user interface. Over time, as the processing capabilities of underlying computing devices evolved, increasingly more complex user interfaces were developed for use with corresponding computer applications. In particular, the advent of the graphical user interface (GUI) resulted in an expectation among end users that a computer application include an intuitive and aesthetically pleasing graphical interface through which end users could effectively interact with the computer application.

Recently, given the popularization of the Internet and the Web, it is no longer reasonable to presume that computer applications are distributed exclusively via disk medium. Rather, in many cases, conventional computer programs are distributed electronically via the Internet. More importantly, however, in many cases computer applications are no longer distributed as stand-alone executable programs. Rather, many computer applications are distributed as Web applications which can include a collection of hypermedia documents such as Web pages which can be viewed in hypermedia content browsers such as Web browsers.

In the case of a Web application, users can interact with the underlying program logic not through a traditional GUI, but through a GUI provided by GUI elements embedded in a hypermedia document displayed in a content browser. For instance, conventional markup languages include tags for defining a form through which users can interact with the program logic. Those tags can be used to define input elements such as radio buttons, text fields and check boxes. Notably, input elements in an application sometimes can have specific formatting or range requirements. These specific formatting or range requirements can be specified as semantic attributes of the input field.

For example, an input field can have attributes defined to indicate the minimum and maximum length or value of data submitted through the input field. Input fields with semantic attributes allow the framework presenting the user interface to validate the contents of the field prior to submitting the data to the back-end application. Validation can be an important aspect of a form inasmuch as the validation process can ensure that user-supplied data comports with a format expected by the underlying program logic. In the typical situation, the validation function can be provided on the client. As a result, form-based processing in Web applications rely heavily upon using client-side computer logic typically implemented using scripting languages such as Visual Basic™ Script, JavaScript™, or newer browser technologies such as Dynamic HTML.

The use of particular scripting languages and browser technologies, however, can hinder platform portability in consequence of browser and interpreter incompatibilities. Furthermore, the use of scripting languages and browser technologies requires the use of scarce resources on the client computer. In many cases, clients hosting content browsers lack a configuration which permits the execution of client-side logic in a content browser. An example of such a circumstance includes content browsers configured only to process documents formatted using hypertext markup language (HTML) v3.2.

### SUMMARY OF THE INVENTION

An enhanced attribute prompting system can include a servlet configured to process requests for enhanced form-based input elements, each request encapsulating at least one input element attribute associated with a requested enhanced form-based input element; and, a graphical element generation processor configured to generate an enhanced form-based input element based upon at least one specified input element attribute provided by the servlet. Each enhanced form-based input element generated by the graphical element generation processor can include a form-based input element and at least one form-based input element attribute prompt. Additionally, the attribute prompt can include least one attribute selected from the group consisting of a textual description of validation criteria, a graphical indication of input-element state, and a graphical indication of an available field action.

A method for enhanced form-based input element attribute prompting can include receiving a request for an enhanced form-based input element, the request encapsulating at least one attribute associated with the enhanced form-based input element; generating the enhanced form-based input element, the generation combining at least one form-based input element with at least one attribute prompt characterizing the at least one form-based input element; and, serving the generated enhanced form-based input element to a content browser configured to render the generated enhanced form-based input element.

The generating step can include parsing the received request, the parsing step producing at least one attribute; producing a prompt for the at least one attribute; and, graphically combining the form-based input element with the produced prompt. The set of producing a prompt can include producing a prompt selected from the group consisting of static text and a graphical icon. Moreover, the step of producing a prompt can include producing a prompt based upon at least one attribute selected from the group consisting of a valid range, a current input element state and an available input element action. Finally, the available input element action can include context sensitive help.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of a system for providing enhanced form prompts in browser clients;

FIG. 2 is an exemplary form including enhanced form prompts in accordance with the inventive arrangements; and,

FIG. 3 is a flow chart illustrating a process for generating and delivering enhanced form prompts to browser clients.

### DETAILED DESCRIPTION OF THE PREFERRED EMBODIMENTS

The present invention is a method and system for providing enhanced form-field attribute prompting in content included as part of a network distributed application. Form-fields are those form-based input fields through which end-users can interact with a network distributed application. Typical form fields are used to collect end-user supplied data, for instance name, address, phone number, etc. Form fields often include permissible attributes, such as minimum and maximum length of data or a suitable range of values. Form field attributes also can include indications of the state of the field, for example whether previously entered data is invalid, and whether context sensitive help is available.

In the present invention, a graphical mechanism can be defined which dynamically presents known attributes of a form-based input or selection field through the use of a field-level prompt. Significantly, this presentation can be performed using the processing resources of the content server rather than the processing resources of the client hosting the content browser. Hence, the present invention can be used to enhance the overall user experience with the application by reducing unnecessary communications between the content browser and the content server. In one aspect of the present invention, the graphical mechanism of the present invention has the advantage of reducing the number of transactions required between Web servers and corresponding client computers running HTML 3.2 Web browsers not having JavaScript or Java capabilities. Still, the invention is not limited only to HTML/Web implementations and the invention can demonstrate equivalent advantages in any arrangement in which a content server can distribute a markup-specified form to a content browser.

The present invention enhances the user interface presented in a content browser such that a displayed field prompt includes a graphical or textual description of any semantic attributes associated with the field to assist the user in correctly entering data therein, particularly for the first time. Notably, the invention can be configured to handle several types of attributes including, but not limited to field formatting and range requirements, field state, and supported field-level actions. Upon entering data in a field which has been formatted and displayed in accordance with the inventive arrangements, if the user does not enter the data correctly, the field validation performed in the server will fail, resulting in the form being re-displayed to the user.

In this regard, it will be apparent to one skilled in the art that as the field validation is performed in the server and not in the client, at least one transaction between the server and client can be avoided. In addition, inasmuch as the end user can be prompting for bounded values based on the semantic attributes at the outset when presenting the form to the end user, the likelihood of the end user failing validation can be reduced. Accordingly, this reduction can result in a corresponding reduction in the number of transactions performed between the client and server. As a result, the user's experience with the network application can be vastly improved.

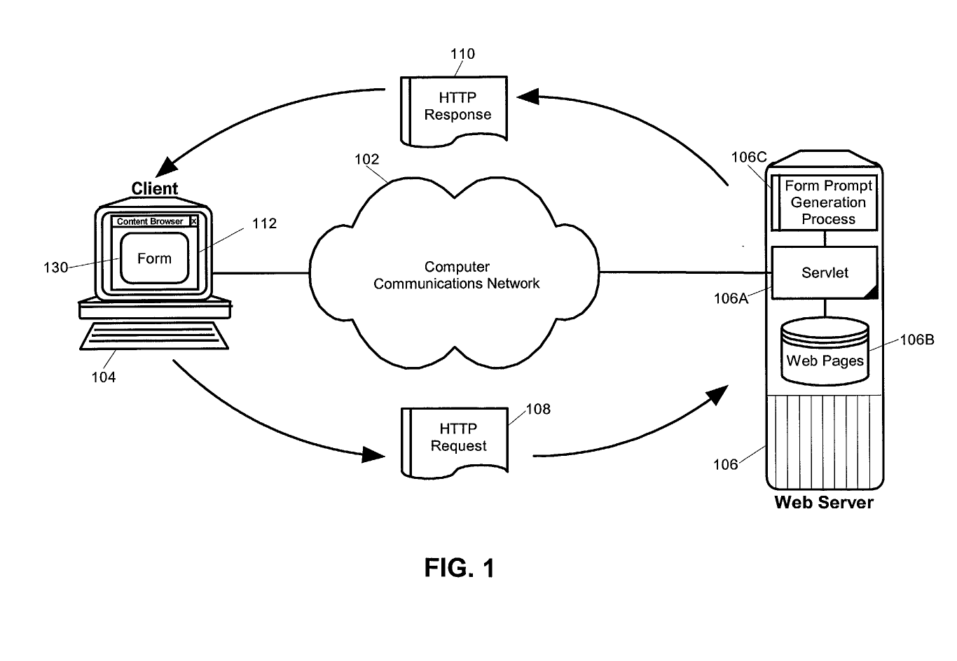

In the preferred embodiment of the present invention, semantic attributes can be included as part of specifying an input or selection field in an HTML 3.2 formatted document. FIG. 1 illustrates a system for providing enhanced form prompts in browser clients configured to process and display HTML 3.2 formatted documents. Notwithstanding, as one skilled in the art will recognize, the system of FIG. 1 is not limited to HTML 3.2 compatible clients as other types of browser clients can suffice. In particular, inasmuch as the present invention provides the advantage of providing an enhanced form prompt for display in a client without requiring enhanced processing capabilities in the client, the scope of the present invention is not limited by the type of client so long as the client can process essential form-based markup tags included in the most basic of markup languages.

As shown in FIG. 1, a system which has been configured in accordance with the inventive arrangements can include a client computer 104 and a server computer 106, communicatively linked through computer communications network 102. In particular, the client computer 104 can include executing thereon, a content browser 130 capable of processing markup formatted content. Conversely, the server computer 106 can host a Web server configured to serve Web pages 106B stored in fixed storage in response to the receipt of a network request 108 for content. The server computer 106 can serve requested content in the form of a network response 110.

As will be apparent to one skilled in the art, the content browser 130 can be a Web browser capable of processing HTML formatted content, including HTML 3.2. In that regard, the server computer 106 can store therein Web pages which can be provided to the client computer 104 in HTTP responses generated upon receiving corresponding suitably formatted HTTP requests. In the preferred embodiment of the present invention, the server computer 106 can provide to the client computer 104 upon request content 130 specifying form-based input. Specifically, the form-based input can include one or more form-based input or selection fields.

In the present invention, it is presumed that the client computer 104 and associated content browser 112 neither can generate enhanced form-based elements nor can validate user-provided data in those form-based elements. An example of a client computer which has been limited in this regard can include a Web browser configured only to process HTML 3.2 formatted content. In that regard, the markup specifying the form-based elements to be displayed in the form 130 can include those input element attributes which can be used to limit the scope of data provided through an associated input element. Additionally, the markup specifying the form-based elements to be displayed in the form 130 also can include the network address of a servlet 106A which has been configured to perform enhanced form-based attribute prompting.

Once the requested content has been received in the client computer 104, the content browser 112 can begin to process the content by interpreting the markup specifying the content. When processing that portion of the content containing the form 130, the content browser can request an enhanced form-based element from the servlet 106 by transmitting such request to the servlet 106A at the address specified by the markup. Notably, the request can include the associated input element attributes. The servlet 106A can receive the request and can forward the request and input element attributes to the form prompt generation processor 106C.

When the form prompt generation processor 106C receives a request to generate an enhanced form-based input or selection element, the form prompt generation processor 106C can parse the request to identify associated attributes. These attributes can include not only validation attributes such as permissible range of values, but also field state and field-level actions. Based upon the parsed attributes, the form prompt generation processor 106C can generate an enhanced form-based input field. Specifically, an image can be generated which includes all pertinent graphical elements necessary to form an enhanced form-based input field. Such graphical elements not only can include icons and form controls, but also mappable, selectable icons and buttons.

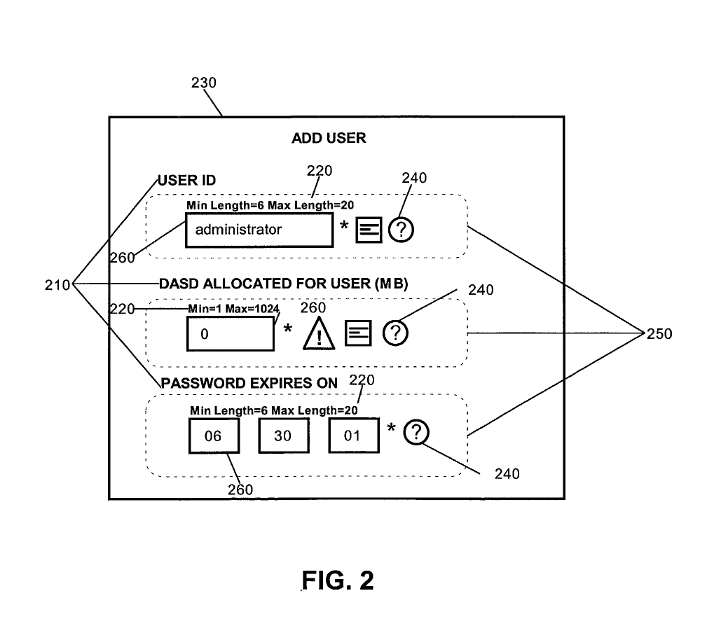

FIG. 2 illustrates a form 230 containing three exemplary enhanced form-based input fields generated by a form prompt generation processor which has been configured in accordance with the inventive arrangements. As shown in FIG. 2, the exemplary form 230 can include three enhanced form-based input fields 250, each field 250 having an associated label 210. Unlike conventional form-based input fields specified in accordance with HTML 3.2 and other such markup languages, the form-based input fields 250 of FIG. 2 include attribute prompting. The attribute prompting includes validation elements 220, as well as field state and action indicators 240. Finally, each enhanced form-based input field 250 includes the input field 260, itself, albeit one skilled in the art will recognize that the invention is not limited merely to input fields, but also can include other types of form-based fields including selection fields, check boxes, etc.

For example, the validation element 220 of the USER ID input field indicates that data to be provided in the text input field 260 has a minimum length of six characters and a maximum length of twenty characters. Additionally, the ‘*’ icon among the state and action indicators 240 indicates that competing the USER ID field is a mandatory exercise. The menu bar icon among the state and action indicators 240 indicates that a context menu is available for the USER ID input field. Finally, the question mark icon among the state and action indicators 240 indicates that context sensitive help is available for the USER ID input field.

The DASD ALLOCATED FOR USER input field includes a numerical input field having a minimum value of one and a maximum value of one-thousand twenty-four. Notably, the exclamation point icon indicates that data previously entered in this field has failed validation. Finally, the PASSWORD EXPIRES ON input field includes a data input field. The validation element 220 of this field specifies that the date is to be entered in United States locale short format. The validation element 220 for this field also specifies a valid date range. As in the case of the USER ID and DASD ALLOCATED FOR USER fields, the PASSWORD EXPIRES ON input field is a mandatory field and includes context sensitive help which can be activated by selecting the question mark icon.

Importantly, one skilled in the art will recognize that the invention is not limited to the example shown in FIG. 2. Rather, it will be readily apparent that the invention can apply equally as well to more conventional circumstances such as the formatting of a date in a text field or an IP address in a text field. Specifically, where a DATE input field requires the entry of a date in a specific format such as MM/DD/YY, the specific format can be visually specified using a validation element such as “format=MM/DD/YY”. By specifying an acceptable format using the validation element, a user can quickly note that other formats such as DD/MM/YYYY will not be acceptable. Similarly, an IP ADDRESS input field can include the validation element NNN.NNN.NNN.NNN to indicate that 116.254.010.010 is an acceptable format while 116.254.10.10 is not acceptable.

Returning now to FIG. 1, once the enhanced form-based input element has been generated, the enhanced form-based input element can be forwarded to the servlet 106A. The servlet 106A, in turn, can transmit the enhanced form-based input element to the content browser 112 in which the enhanced form-based input element can be rendered in the form 130. Once displayed, the enhanced form-based input element can assist the end-user's completion of the form 130. As a result, the number of transactions between the client computer 104 and server computer 106 necessary to validate data supplied by the end-user through the form 130 can be reduced without further requiring validation processing in the client computer 104.

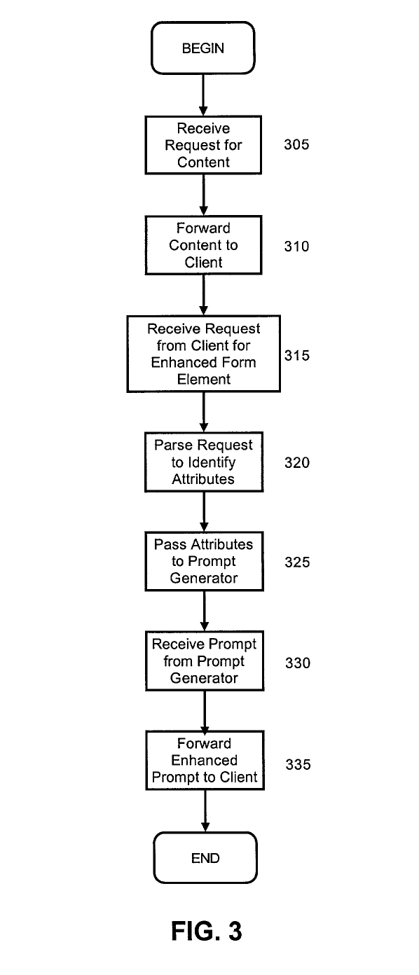

FIG. 3 is a flow chart illustrating a process for generating and delivering enhanced form prompts to browser clients. The process can be performed in an application server, a Web server or any other suitable content server. Beginning in step 305, a request for content can be received, responsive to which in step 310, the requested content can be forwarded to the requesting client. In the preferred embodiment of the present invention, the requested content can be a Web page specified by markup such as HTML 3.2. Notwithstanding, in other embodiments, the Web page can be specified by other markup languages, including XML. In the case of XML, the attributes of an input field can be specified as child elements of the field.

Importantly, the requested content can include markup which specifies a form. More particularly, the portion of the markup which specifies the form can include one or more form-based input elements formatted in accordance with the inventive arrangements described herein. The inventive formatting can include validation attributes in addition to state and field action attributes, and a network address of program logic configured to process the attributes and to generate an enhanced form-based input element. As one skilled in the art will recognize, the markup not only can conform to the HTML specification, but also the markup can conform to other markup language specifications, for instance XML, WML and other SGML variants.

In step 315, a request can be received from a content browser which has attempted to render the content forwarded in step 310. The request can be generated based upon the network address and attributes included in the form-input field. In step 320, the request can be parsed in order to identify the attributes contained therein. In step 325, those identified attributes can be forwarded to the form prompt generation processor which can generate an enhanced input-field element based upon those forwarded attributes. In step 330, the generated input-field element can be received from the form prompt generation processor and in step 335, the generated input-field element can be forwarded to the client computer.

Significantly, in the preferred embodiment, all content browsers which support HTML 3.2 can capitalize on the use of the system and method of the invention, thus achieving portability across many platforms, all the while avoiding JavaScript and DOM browser incompatibilities. Additionally, as the present invention supports HTML 3.2 content browsers, the validation processing associated with the display of these attributes is performed in the server and not in the client. As a result, the resources of the client are free for use by other processes.

The present invention can be realized in hardware, software, or a combination of hardware and software. The enhanced attribute prompting system of the present invention can be realized in a centralized fashion in one computer system, or in a distributed fashion where different elements are spread across several interconnected computer systems. Any kind of computer system, or other apparatus adapted for carrying out the methods described herein, is suited.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. An enhanced form-based input element attribute prompting system comprising:
a servlet configured to process requests for enhanced form-based input elements, each said request encapsulating at least one input element attribute associated with a requested enhanced form-based input element; and,
a graphical element generation processor configured to generate an enhanced form-based input element based upon at least one specified input element attribute provided by said servlet.

2. The enhanced attribute prompting system of claim 1, wherein each enhanced form-based input element generated by said graphical element generation processor comprises a form-based input element and at least one form-based input element attribute prompt.

3. The enhanced attribute prompting system of claim 2, wherein said at least one attribute prompt comprises at least one attribute selected from the group consisting of a textual description of validation criteria, a graphical indication of input-element state, and a graphical indication of an available field action.

4. A method for enhanced form-based input element attribute prompting, the method comprising:
receiving a request for an enhanced form-based input element, said request encapsulating at least one attribute associated with said enhanced form-based input element;
generating said enhanced form-based input element, said generation combining at least one form-based input element with at least one attribute prompt characterizing said at least one form-based input element; and,
serving said generated enhanced form-based input element to a content browser configured to render said generated enhanced form-based input element.

5. The method of claim 4, wherein said generating step comprises:
parsing said received request, said parsing producing at least one attribute;
producing a prompt for said at least one attribute; and,
graphically combining said at least one form-based input element with said produced prompt.

6. The method of claim 5, wherein said set of producing a prompt comprises:
producing a prompt selected from the group consisting of static text and a graphical icon.

7. The method of claim 5, wherein said step of producing a prompt comprises:
producing a prompt based upon at least one attribute selected from the group consisting of a valid range, a current input element state and an available input element action.

8. The method of claim 7, wherein said available input element action comprises context sensitive help.

9. A machine readable storage having stored thereon a computer program for enhanced form-based input element attribute prompting, the computer program comprising a routine set of instruction for causing the machine to perform the steps of:
receiving a request for an enhanced form-based input element, said request encapsulating at least one attribute associated with said enhanced form-based input element;
generating said enhanced form-based input element, said generation combining at least one form-based input element with at least one attribute prompt characterizing said at least one form-based input element; and,
serving said generated enhanced form-based input element to a content browser configured to render said generated enhanced form-based input element.

10. The machine readable storage of claim 9, wherein said generating step comprises:
parsing said received request, said parsing producing at least one attribute;
producing a prompt for said at least one attribute; and,
graphically combining said at least one form-based input element with said produced prompt.

11. The machine readable storage of claim 10, wherein said set of producing a prompt comprises:
producing a prompt selected from the group consisting of static text and a graphical icon.

12. The machine readable storage of claim 10, wherein said step of producing a prompt comprises:
producing a prompt based upon at least one attribute selected from the group consisting of a valid range, a current input element state and an available input element action.

13. The machine readable storage of claim 12, wherein said available input element action comprises context sensitive help.
